(19) United States
(12) Patent Application Publication
(10) Pub. No.: US 2006/0036936 A1
(43) Pub. Date: Feb. 16, 2006

(54) Method and apparatus for playing multimedia

(76) Inventor: Angel Chen, Hsin-Tien City (TW)

Correspondence Address: J C PATENTS, INC., 4 VENTURE, SUITE 250, IRVINE, CA, 92618, US

(21) Appl. No.: 11/148,812

(22) Filed: Jun. 8, 2005

(30) Foreign Application Priority Data
Aug. 12, 2004 (TW) 93124165

(51) Int. Cl. G06F 17/24; G06F 17/21

(52) U.S. Cl. 715/501.1

(57) ABSTRACT

A method and an apparatus for playing multimedia are comprised by the following steps. First, a multimedia is played using an apparatus. The playing multimedia is stopped after a preset period of time through a predetermined procedure and all commands for operating the apparatus are also disabled. After the passage of a predefined stopping period, the multimedia continues to play from where it has stopped and then all commands for operating the apparatus are enabled again.

### CROSS-REFERENCE TO RELATED APPLICATION

This application claims the priority benefit of Taiwan application serial no. 93124165, filed on Aug. 12, 2004. All disclosure of the Taiwan application is incorporated herein by reference.

### BACKGROUND OF THE INVENTION

1. Field of the Invention

The present invention relates to a method and apparatus for playing multimedia. More particularly, the present invention relates to a method and apparatus for playing multimedia that automatically tracks and limits the playback duration.

2. Description of the Related Art

In modern day life, multimedia playback apparatus such as VCRs and DVDs are very common in our families. Because of its popularity and high recreational values, a few frustrating problems are sometimes created in our home. For example, a family with children is often upset when children spend too much time watching media programs, thereby hurting their eyes while ignoring school works. However, stopping the apparatus manually or switching the apparatus off forcefully frequency leads to parent/child conflicts. Even for the adults, over-watching may sometimes interfere with their work.

Therefore, a technique is needed to permit the owner (or administrator) of a multimedia playback apparatus the option of controlling the playing time so that the users of the playback apparatus will not waste too much time.

### SUMMARY OF THE INVENTION

Accordingly, at least one objective of the present invention is to provide a method of automatically controlling the playing period of a multimedia so that the media watching hours for children and adults alike can be better administered. Hence, the eyesight of small children is protected and conflicts due to manual stopping or switching is reduced.

To achieve these advantages and in accordance with the purpose of the invention, as embodied and broadly described herein, the invention provides a method of playing multimedia comprising the following steps. First, a playback apparatus is used to play a multimedia. The playing multimedia is stopped after a preset period of time through a predetermined procedure and all commands for operating the apparatus are also disabled. After the passage of a predefined stopping period, the multimedia continues to play from where it has stopped and then all commands for operating the apparatus are enabled again.

The present invention also provides an apparatus for playing multimedia comprising a presetting device for registering a playing time, a stopping procedure and a stopping time and a playback apparatus for receiving the playing time, the stopping procedure and the stopping time data from the presetting device. After playing a multimedia for a definite period of time according to the playing time, the playing is stopped according to the user-specified stopping procedure. After the passage of the aforementioned stopping time, the playing is continued from where it has stopped. Furthermore, all commands for operating the apparatus are disabled during the stopping period so that nobody can re-start the apparatus and continue to watch the multimedia.

Accordingly, the present invention utilizes a preset program to terminate a playback operation automatically without any human interference. Moreover, nobody can override the commands in the preset program (unless somebody has received a code from an administrator) by inputting through the playback apparatus. Thus, less parental/children argument flares up and the watching hour can be limited to protect the eyesight of children.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the list of parameters that can be selected to control multimedia playing and protect the eyesight of people according to one embodiment of the present invention.

FIG. 2 is a flow diagram showing in detail the steps for playing multimedia and protecting people's eyesight according to one embodiment of the present invention.

FIG. 3 is a block diagram showing the major components of a playback apparatus for protecting people's eyesight according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following, a multimedia playback method capable of preserving people's eyesight is disclosed. The present embodiment can be applied to most multimedia player or player/recorder or any apparatus capable of playing multimedia.

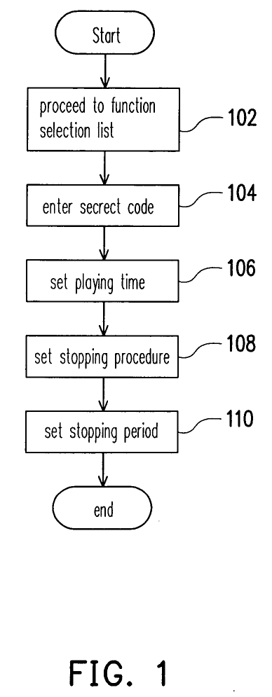

The steps in the embodiment of the present invention include the following. First, a playback apparatus is used to play a multimedia. After a preset period of time, a predetermined procedure is used to stop playing the multimedia. At the same time all commands for operating the apparatus are also disabled (or locked) so that the user cannot re-start the playing through any commands. After the passage of a predefined stopping period, the multimedia continues to play from where it has stopped. In the meantime, all commands for operating the apparatus are enabled so that the user may resume the control of the playback apparatus again. Before playing the multimedia, a user needs to provide the playback apparatus with a list of selections for setting the playing time, the stopping procedure and the stopping period. The list of selections may exist independently or is a subsidiary part of another more complete system. The setting procedure and steps are depicted in FIG. 1.

First, the user proceeds to a function selection list in step 102. Thereafter, the user enters a secret code in step 104 and sets the playing time in step 106. In the present embodiment, the playing time is based on hours and minutes. After that, the user sets the stopping procedure in step 108. In the present embodiment, there are two stopping procedures: stopping temporarily or shutting down the playback apparatus. Finally, the user sets the stopping period in step 110. In the present embodiment, the stopping time can be infinite so that the apparatus will never play once the apparatus is shut. Furthermore, the settings are retained even after shutdown so that the settings are still valid until the user performs another functional selection to enter new parameters.

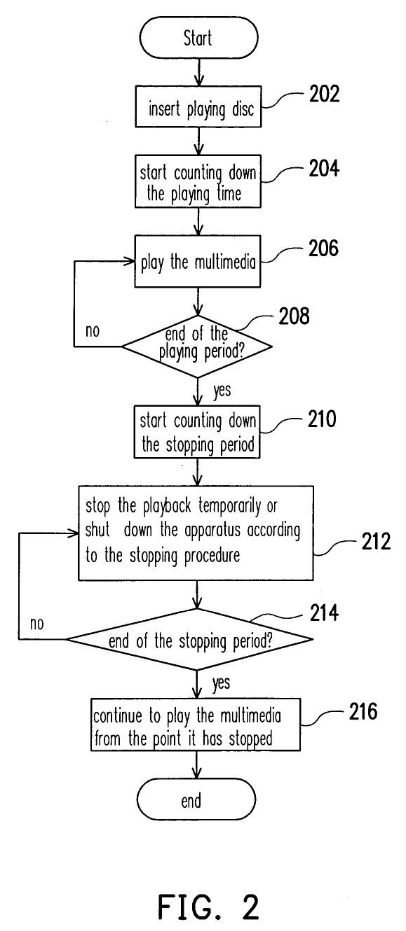

FIG. 2 is a flow diagram showing in detail the steps for playing multimedia and protecting people's eyesight according to one embodiment of the present invention. First, the user places pre-recorded multimedia discs into the playback apparatus in step 202. The playback apparatus starts counting down to the playing time in step 204. The countdown starts immediately after the discs are put inside the playback apparatus. Thereafter, the playback apparatus starts playing the multimedia discs in step 206. In step 208, the playing time is monitored and constantly checked to determine if the end of the playing period has arrived. If there is still some playing time left, control returns to step 206 with the apparatus continuing to play the multimedia. Otherwise, step 210 is carried out.

In step 210, a countdown to the stopping period is initiated. In step 212, according to the user's preset stopping procedure, the program code for controlling the software is called to simulate user operation so that the playback is temporarily stopped or the apparatus is directly shut. During the temporarily suspension of the apparatus, the user can initiate another parameter selection while all other commands for operating the apparatus remains invalid. On the other hand, if the user's setting is to shut down the apparatus, the playback apparatus will normally register the current playing time so that playback can resume from this point forward instead of starting from the very beginning. Obviously, the user may choose to start from the very beginning or a specified portion (the present invention has no particular restriction on this). Thereafter, in step 214, the countdown is assessed to determine if the stopping period has already ended. If the stopping period has not yet finished, control returns to step 212 so that the apparatus remains in a temporarily stopping state or a shutdown state. However, if the stopping period has ended, step 216 is executed so that the playing is resumed from where the multimedia has stopped.

In the present embodiment, the playback apparatus will resume playing the multimedia as soon as the stopping period ends and will not stop or shut down unless the user asks the apparatus to do so by submitting a stop or shutdown command. Obviously, the playback apparatus may execute a certain number of playback and stopping (or shutdown) cycles through a presetting operation. In this case, the cycles are repeated until the playback of the multimedia discs is completed or preset number of cycles has already been executed.

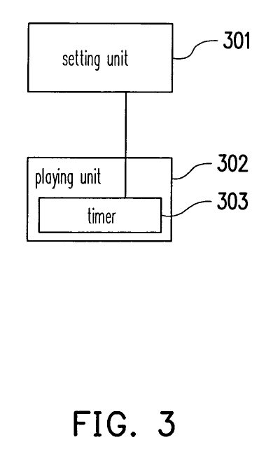

FIG. 3 is a block diagram showing the major components of a playback apparatus for protecting people's eyesight according to one embodiment of the present invention. The apparatus comprises a setting unit 301 and a playing unit 302. The playing unit 302 further comprises a timer 303. The setting unit 301 receives a user-input code. After confirming the correctness of the code, the setting unit 301 recorded the user-set playing time, stopping procedure and stopping period. The playing unit 302 receives the preset playing time, the stopping procedure and the stopping period. Thereafter, the playing unit 302 starts playing a multimedia. At the end of the playing time, the playing unit 302 stops playing the multimedia (or even disabled all operating commands) according to the preset stopping procedure. After the passage of the stopping period, the playing unit 302 is restarted from the point where the playing has stopped (or enabled all operating commands again).

The timer 303 inside the playing unit 302 is responsible for counting down the playing time and the stopping time. The countdown of the playing time starts as soon as a playing disc is inserted into the multimedia playback apparatus.

In summary, the multimedia playback apparatus and the method of operating the apparatus according to the present invention utilizes a set of user-preset parameters to control the stopping of a playback operation automatically without human intervention. Furthermore, all operating commands are disabled during the stopping period so that the user is prevented from restarting the playback again.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of playing back a multimedia, comprising the steps of:
recording at least a preset playing time, at least a preset stopping period and at least a preset stopping procedure;
playing a multimedia and counting the period from the beginning of the multimedia;
stopping the playback of the multimedia according to the preset stopping procedure when the multimedia has been playing for a period equal to the preset playing time and counting the period from the moment the playback of the multimedia stops; and
playing the multimedia again when the playback of the multimedia has already stopped for a time interval equal to the present stopping period.

2. The multimedia playback method of claim 1, wherein at least a command for playing the multimedia is disabled as soon as the playback of the multimedia has stopped.

3. The multimedia playback method of claim 2, wherein at least a command for playing the multimedia is enabled as soon as the playback of the multimedia is resumed.

4. The multimedia playback method of claim 1, wherein the playback method further comprises the following steps:
receiving a secret code at the same time as recording the playing time, the stopping procedure and the stopping period;
checking the correctness of the secret code; and
starting to play the multimedia according to the preset playing time, the preset stopping procedure and the preset stopping period when the secret code is found to be correct.

5. The multimedia playback method of claim 1, wherein the playback method further comprises:
the command for receiving a secret code is still enabled although the command for playing the multimedia is disabled after the playback of the multimedia has stopped.

6. The multimedia playback method of claim 1, wherein the stopping procedure is selected from a group consisting of stopping the multimedia playback temporarily and stopping the multimedia playback permanently.

7. The multimedia playback method of claim 1, wherein after temporarily suspending the playback of the multimedia, only a few special operating commands are accepted including a command for changing the preset playing time, a command for changing the preset stopping period and a command for changing the preset stopping procedure.

8. The multimedia playback method of claim 1, wherein the countdown of the playing time starts from the moment a playing disc is inserted into the playback apparatus.

9. A multimedia playback apparatus, comprising:
a setting unit for registering at least a playing time, at least a stopping procedure and at least a stopping period provided by a user; and
a playing unit for receiving the preset playing time, the preset stopping procedure and the stopping period, wherein the playing unit plays a multimedia for a duration equal to the playing time duration, then stops playing the multimedia according to a stopping procedure and continues to play the multimedia at the end of the stopping period.

10. The multimedia playback apparatus of claim 9, wherein at least one command for playing the multimedia is disabled as soon as the playing unit stops playing the multimedia.

11. The multimedia playback apparatus of claim 10, wherein at least a command for playing the multimedia is enabled as soon as the playback of the multimedia is resumed.

12. The multimedia playback apparatus of claim 9, wherein one other service provide by the setting unit further comprises:
receiving a secret code, wherein the playing time, the stopping procedure and the stopping period are registered after the secret code is verified to be the correct one.

13. The multimedia playback apparatus of claim 12, wherein one other service provided by the playing unit comprises:
the command for receiving a secret code is still enabled although the command for playing the multimedia is disabled after the playback of the multimedia has stopped.

14. The multimedia playback apparatus of claim 9, wherein the stopping procedure is selected from a group consisting of stopping the multimedia playback temporarily and stopping the multimedia playback permanently.

15. The multimedia playback apparatus of claim 9, wherein after temporarily suspending the playback of the multimedia, only a few special operating commands are accepted including a command for changing the preset playing time, a command for changing the preset stopping period and a command for changing the preset stopping procedure.

16. The multimedia playback apparatus of claim 9, wherein the playing unit further comprises:
a timer for counting down the playing time and the stopping period.

17. The multimedia playback apparatus of claim 16, wherein the countdown of the playing time starts from the moment a playing disc is inserted into the playback apparatus.
